(19) United States
(12) Patent Application Publication
(10) Pub. No.: US 2016/0171516 A1
(43) Pub. Date: Jun. 16, 2016

(54) PROXIMITY AND DURATION BASED TRANSACTION ASSISTANCE DETERMINATION

(71) Applicant: TOSHIBA GLOBAL COMMERCE SOLUTIONS HOLDINGS CORPORATION, Tokyo (JP)

(72) Inventors: Susan Winter BROSNAN, Raleigh, NC (US); Dean Frederick HERRING, Youngsville, NC (US); Brad Matthew JOHNSON, Raleigh, NC (US); Adrian Xavier RODRIGUEZ, Durham, NC (US); Jeffrey John SMITH, Raleigh, NC (US)

(21) Appl. No.: 14/566,499

(22) Filed: Dec. 10, 2014

(51) Int. Cl. G06Q 30/02; G06Q 30/06

(52) U.S. Cl. CPC G06Q 30/0214; G06Q 30/0633; G06Q 30/0639

(57) ABSTRACT

Systems, methods, and computer program products to perform an operation comprising: calculating a first duration of time of a first interaction between a first person and an object, detecting a second interaction between the first person and a second person based on at least one of: a proximity between the first person and the second person, the proximity being detected by a proximity detection module, and a second duration of time during which the first person and the second person remain in the proximity, and upon determining that the first person has purchased the object: computing, by operation of one or more processors, an award to apply to the second person; wherein the processors compute the award on the basis of one or more rules that take as inputs the first interaction and the second interaction.

### BACKGROUND

The present disclosure relates to computer software, and more specifically, to computer software to provide proximity and duration based transaction assistance determination.

Sales associates in retail stores may receive commissions when they complete a sale. Currently, the sales associate is identified by entering an associate ID or swiping an ID card at a sales terminal. However, the sales associate identified at the sales terminal may not be the sales associate who earned the commission, as customers may interact with many sales associates during their visit to a retail store.

### SUMMARY

Aspects disclosed herein include systems, methods, and computer program products to perform an operation comprising: calculating a first duration of time of a first interaction between a first person and an object, detecting a second interaction between the first person and a second person based on at least one of: a proximity between the first person and the second person, the proximity being detected by a proximity detection module, and a second duration of time during which the first person and the second person remain in the proximity, and upon determining that the first person has purchased the object: computing, by operation of one or more processors, an award to apply to the second person; wherein the processors compute the award on the basis of one or more rules that take as inputs the first interaction and the second interaction.

### BRIEF DESCRIPTION OF THE SEVERAL VIEWS OF THE DRAWINGS

FIG. 1 illustrates a system which provides proximity and duration based transaction assistance determination, according to one aspect.

FIG. 2 is a schematic illustrating techniques to provide proximity and duration based transaction assistance determination, according to one aspect.

FIG. 3 illustrates a method to compute sales associate commissions, according to one aspect.

FIG. 4 illustrates a method to monitor customer interactions with products, according to one aspect.

FIG. 5 illustrates a method to monitor customer interactions with sales associates, according to one aspect.

FIG. 6 illustrates a method to compute commissions, according to one aspect.

FIG. 7 illustrates components of a checkout application, according to one aspect.

### DETAILED DESCRIPTION

Aspects disclosed herein award sales commissions by monitoring interactions between customers and products as well as customers and sales associates in retail stores. By identifying which sales associate is interacting a customer when the customer interacts with a product, aspects disclosed herein may correctly identify the sales associate(s) who have earned a commission. Aspects disclosed herein may leverage any type of technology to detect and monitor interactions between customers and products, as well as interactions between sales associates and customers. Examples of such technologies include, without limitation, in-store cameras, iBeacons®, microphones, global positioning systems GPS, near field communications (NFC), and Bluetooth®.

For example, a set of cameras in a retail store may detect a customer pick up a commercial product, like a tablet computer, a television, a radio, and the like. A short time later, a sales associate may approach the customer to provide assistance. The interaction between the customer and the sales associate may be based at least in part on the proximity between the customer and the sales associate. The proximity may be detected by the cameras, their position in the store (using GPS, for example), or wireless modules on their respective mobile devices. The proximity may be detected when the customer and the sales associate are close to each other to some extent, for example within 3 meters. Aspects disclosed herein may then record attributes of the interactions between the customer and the product, as well as the customer and the sales associate. For example, a system may record the amount of time the customer held the tablet, and then determine that the customer placed the tablet in his cart for purchase. Similarly, a microphone on the sales associate's phone may be used to record the conversation between the sales associate and the customer. In such aspects, if the sales associate initiates the recording process, the wireless device could signal the beginning of an interaction between the customer and the sales associate. As such, aspects disclosed herein may identify the customer the sales associate is interacting with (for example, via cameras, detecting the customer's wireless device, and the like) and what products are nearby (also via cameras, iBeacons, GPS, and the like).

The audio recording of the conversation may then be analyzed by software which transcribes the conversation, then analyzes the text of the conversation in order to identify a level of service provided by the sales associate. For example, the software may determine that the sales associate answered many questions for the customer, and the customer expressed great appreciation for the sales associate's assistance. If the customer subsequently purchases the tablet from the retailer, aspects disclosed herein may award the sales associate a commission based on the customer's interaction with the product, the sales associate, a length of time of the interactions, the quality of the interactions, and any other business rules for awarding commissions.

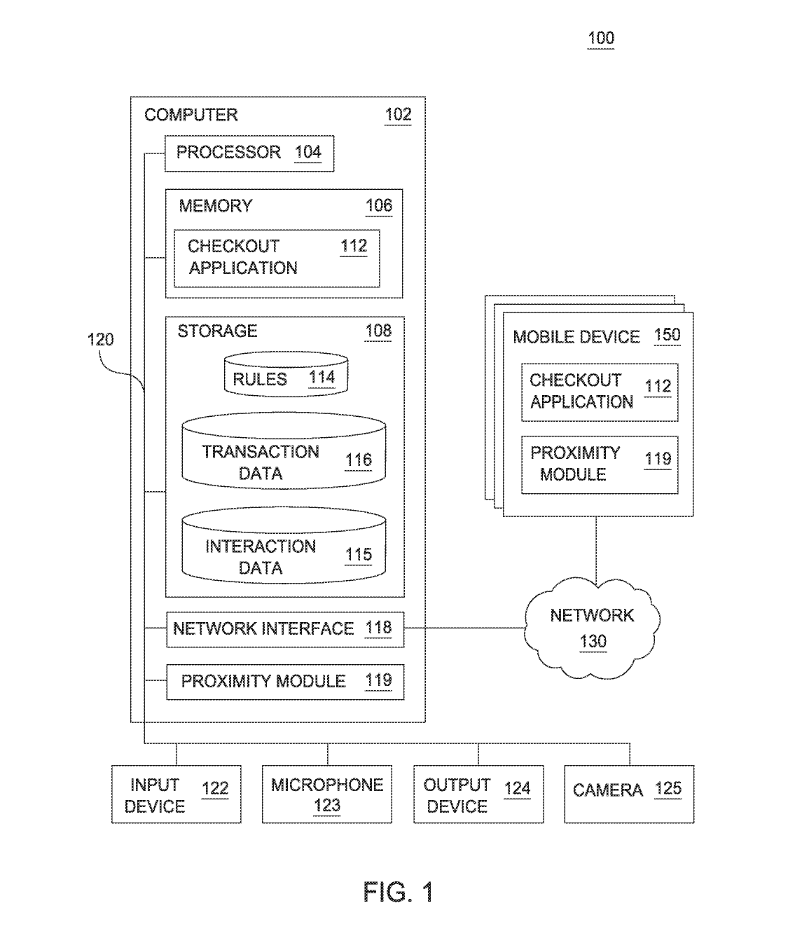

FIG. 1 illustrates a system 100 which provides proximity and duration based transaction assistance determination, according to one aspect. The networked system 100 includes a computer 102. The computer 102 may also be connected to other computers via a network 130. In general, the network 130 may be a telecommunications network and/or a wide area network (WAN). In a particular embodiment, the network 130 is the Internet.

The computer 102 generally includes a processor 104 which obtains instructions and data via a bus 120 from a memory 106 and/or a storage 108. The computer 102 may also include one or more network interface devices 118, input devices 122, and display devices 124 connected to the bus 120. The computer 102 is generally under the control of an operating system (not shown). Examples of operating systems include the UNIX operating system, versions of the Microsoft Windows operating system, and distributions of the Linux operating system. (UNIX is a registered trademark of The Open Group in the United States and other countries. Microsoft and Windows are trademarks of Microsoft Corporation in the United States, other countries, or both. Linux is a registered trademark of Linus Torvalds in the United States, other countries, or both.) More generally, any operating system supporting the functions disclosed herein may be used. The processor 104 is a programmable logic device that performs instruction, logic, and mathematical processing, and may be representative of one or more CPUs. The network interface device 118 may be any type of network communications device allowing the computer 102 to communicate with other computers via the network 130.

The storage 108 is representative of hard-disk drives, solid state drives, flash memory devices, optical media and the like. Generally, the storage 108 stores application programs and data for use by the computer 102. In addition, the memory 106 and the storage 108 may be considered to include memory physically located elsewhere; for example, on another computer coupled to the computer 102 via the bus 120.

The input device 122 may be any device for providing input to the computer 102. For example, a keyboard and/or a mouse may be used. The input device 122 represents a wide variety of input devices, including keyboards, mice, controllers, and so on. Furthermore, the input device 122 may include a set of buttons, switches or other physical device mechanisms for controlling the computer 102. The display device 124 may include output devices such as monitors, touch screen displays, and so on. In the illustrative embodiment, the system 100 also includes a camera 125, which may be any device configured to capture image data. In at least one aspect, the camera 125 comprises a plurality of security cameras in a retail store. The camera(s) 125 may be fixed in place such as one that is mounted from a ceiling or wall by means of a mounting bracket; or, the camera(s) 125 may be movable such as one mounted to an airborne drone capable of being navigated to different positions within a retail environment. A proximity module 119 is any hardware element that can be leveraged to determine a position of a device and/or proximity of the device to other devices. Examples of the proximity module 119 include, without limitation, global positioning system (GPS) radios, Bluetooth® radios, wireless network adapters, near field communications (NFC) radios, iBeacons®, and the like. A microphone 123 is configured to capture and/or record audio. As with the cameras 125, the microphone 123 may be fixed in space, or movable.

As shown, the memory 108 includes a checkout application 112, which is an application configured to process customer transactions and compute commissions for sales associates. To compute and award commissions, the checkout application 112 may monitor interactions between customers and products as well as interactions between sales associates and customers, and apply one or more business rules from the rules 114 to determine if a sales associate is entitled to a commission. The checkout application 112 may further collect data points regarding the interactions in order to compute any commissions due to sales associates. For example, and without limitation, the checkout application 112 may process image data from the cameras 125 to determine that a customer picked up a network router in a computer store. The checkout application 112 may monitor the customer's interaction with the router, such as how long he holds the router, his actions in interacting with the router, and the like.

The checkout application 112 may also determine that a sales associate approached the customer shortly after the customer picked up the router. The checkout application 112 may determine that the sales associate is near the customer using image data from the camera 125. In one aspect, a plurality of mobile devices 150 may be provisioned with respective instances of proximity modules 119. The mobile devices 150 may be carried by sales associates and/or customers, and may be personal mobile devices owned by the sales associates and/or customers as well as mobile devices provided to the sales associate and/or customers by a retailer in a retail store. One example of mobile devices provided by retailers includes handheld devices used to scan items as part of a self checkout process. The checkout application 112 can then determine the proximity of the sales associate and the customer by receiving data from respective instances of proximity modules 119 executing on mobile devices 150 of the customer and/or the sales associate. For example, the checkout application 112 may determine, using GPS radios in the mobile devices 150, that the sales associate and the customer are less than one meter apart. In such a case, the checkout application 112 may monitor the interactions between the sales associate and the customer. The checkout application 112 may capture any data attribute related to the interactions, such as the interaction's duration of time, amount of conversation, record the conversation, identify whether the sales associate offers the customer other products to consider, and the like. Generally, the checkout application 112 may store all collected data regarding customer/sales associate interactions and customer/product interactions in the interaction data 115.

In at least one aspect, the checkout application 112 may compute a score reflecting a level of interaction between the customer and sales associate. In computing a score for the interaction, the checkout application 112 may consider any factor, such as the duration of the interaction, the subject matter of a recorded conversation, whether the customer had already decided to purchase the product prior to interacting with the sales associate, and the like. For example, if the customer already had the router in his shopping cart (or paid for the router using the checkout application 112 on the mobile device 150) upon being engaging with the sales associate, the level of interaction may be relatively low, and the checkout application 112 may not award the sales associate a commission. However, if the conversation indicates that the customer asked many questions of the sales associate, and the sales associate provided thorough answers to the customer, the checkout application 112 may compute a high score for the interaction, which may result in a full commission for the sales associate.

When a customer purchases a product, the checkout application 112 may also determine whether a sales associate interacted with the customer and has earned a commission. The customer may purchase the product in the retail store, or may purchase the product via an online store of the retailer at a later time. In at least one aspect, the checkout application 112 may reference data in the interaction data 115 to identify data related to interactions between a sales associate and the customer making a purchase. If the checkout application 112 determines that a sales associate interacted with the customer, the checkout application 112 may determine which, if any, of the sales associates interacting with the customer has earned a commission. In determining which sales associates have earned a commission, the checkout application 112 may leverage the data in the interaction data 115 as well as one or more business rules for computing commissions in the rules 114. Upon computing any earned commissions, the checkout application 112 may store indications of the earned commissions in the transaction data 116.

As shown, the storage 108 includes the rules 114, interaction data 115, and transaction data 116. The rules 114 is configured to hold business rules related to commissions for sales associates. Generally, the rules 114 may include any type of rules related to commissions. For example, a first rule 114 may specify that cashiers are not eligible for commissions unless the cashier actually caused the customer to purchase a specific product. As another example, a second rule 114 may specify that more than one sales associate may share a commission for any given sale. As another other example, the rules 114 may specify minimum interaction time thresholds for customers and sales associates. For example, a sales associate may be required to interact with a customer for more than 10 seconds (a threshold time) in order to be eligible for a commission. As still another example, the rules 114 may specify time thresholds within which a customer must interact with a product and a sales associate in order for the sales associate to be eligible for a commission. For example, a rule in the rules 114 may specify that a sales associate must interact with a customer within 10 seconds of the time the customer interacts with a product. Doing so allows the checkout application 112 to award commissions to sales associates whose assistance was a factor in the customer purchasing a product, versus sales associates who exchange pleasantries with customers.

The interaction data 115 may include data reflecting interactions between customers and products as well as interactions between customers and sales associates. Generally, any type of data may be stored in the interaction data 115, such as video of interactions, images of interactions, audio recordings of interactions, data describing interactions (also referred to as interaction metadata), and the like. For example, a first interaction entry in the interaction data 115 may specify that a camera 125 captured a customer holding a product for 30 seconds, and then placing the product in their shopping cart. The first interaction entry may also include images of the customer captured by the camera 125 while holding the product and placing the product in the shopping cart. As another example, a second interaction entry in the interaction data 115 may include an audio recording of a conversation between a sales associate and a customer captured by a microphone 123, reflect a location in the retail store where the conversation occurred based on a proximity module 119, a duration of the conversation, and an indication of any products discussed or interacted with during the conversation. Similarly, the interaction data 115 may reflect that a customer picked up a product, scanned a product with the checkout application 112 on their mobile device 150, and the like. The transaction data 116 stores data describing purchases made by customers, and may include any commissions computed and awarded by the checkout application 112.

As shown, a plurality of mobile devices 150 may also execute instances of the checkout application 112. The mobile devices 150 may be any type of device, such as laptops, tablet computers, smartphones, and the like. The instances of the checkout application 112 executing on the mobile devices 150 may leverage proximity modules 119, cameras 125, and/or microphones 123 as described above to detect and monitor interactions between customers and products, and customers and sales associates. Doing so may allow the checkout application 112 to more accurately compute and award commissions for the correct sales associate.

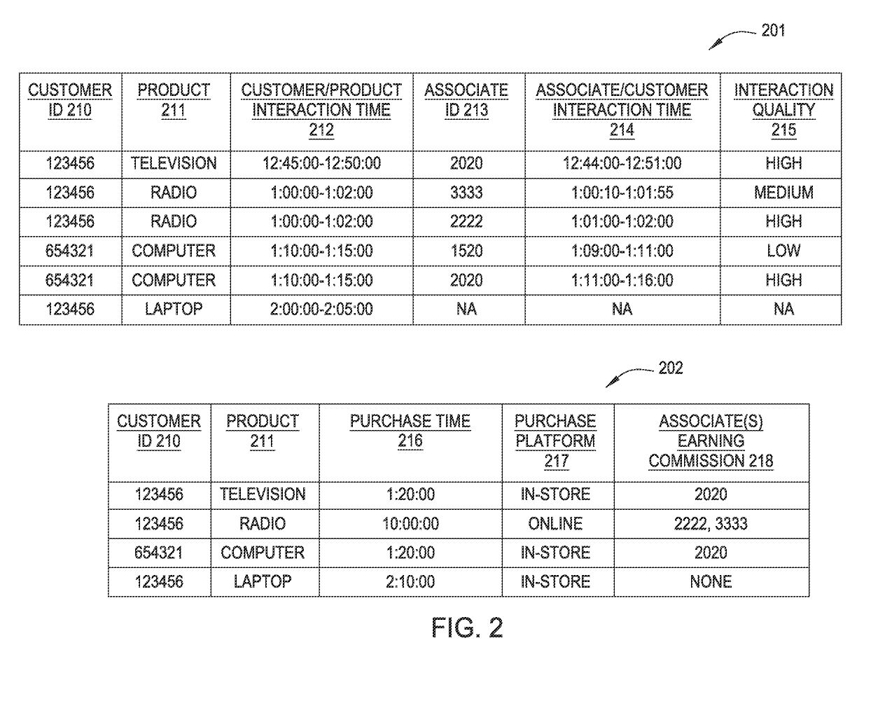

FIG. 2 is a schematic 200 illustrating techniques provide proximity and duration based transaction assistance determination, according to one aspect. As shown, a table 201 includes interaction data between customers and products, as well as customers and sales associates. In at least one aspect, the table 201 reflects data generated and stored in the interaction data 115 by the checkout application 112. The table includes columns for a customer identifier 210, a product 211, a customer and product interaction time 212, an associate identifier 213, an associate and customer interaction time 214, and an interaction quality 215. The customer ID 210 and associate ID 213 are identifiers for customers and sales associates, respectively. The products 211 describe the products a customer 210 may interact with. The interaction times 212 and 214 reflect a time and duration of interactions between customers and products, and customers and sales associates, respectively. The interaction quality 215 reflects a score computed by the checkout application 112 for the interaction between the sales associates and customers.

As shown, for example, a customer having customer ID 123456 interacted with a television from 12:45 through 12:50. In addition, a sales associate having an associate ID of 202 interacted with the customer from 12:44 through 12:51. Furthermore, the checkout application 112 computed an interaction quality score which reflects a high quality of interaction between the customer and sales associate. The checkout application 112 may compute the interaction quality score based on any number of attributes. For example, the checkout application 112 may note that the customer interacted with the sales associate prior to interacting with the television, indicating that the sales associate suggested the customer consider purchasing the television. Similarly, the checkout application 112 may note that the customer interacted with the sales associate even after the customer's interaction with the television had stopped. The checkout application 112 may determine, therefore, that the sales associate provided a high level of interaction quality to the customer, as the customer did not immediately leave the sales associate after stopping their interaction with the television.

Table 202 reflects transaction data for purchases made by customers, and includes the customer ID 210, product 211 being purchased, a purchase time 216, a purchase platform 217, and any associates earning commission 218. The purchase time 216 indicates when a customer purchased the product, and the purchase platform 217 indicates where the customer purchased the product (such as in a retail store or online). The associates earning commission 218 reflect which, if any, sales associates have earned a commission for the sale of the product. When a customer purchases a product, the checkout application 112 may determine, based at least in part on the data in the table 201, whether any sales associates are entitled to a commission. As shown, for example, the checkout application 112 determined that sales associate 2020 is entitled compensation for customer 123456's purchase of a television. The checkout application 112 may have made this determination based on the high quality of the interaction from table 201, the length of the interaction between the customer and sales associate, and the timing of the customer's interaction with the associate relative to the customer's interaction with the television.

In some aspects, multiple sales associates may earn commissions. As shown, for example, associates 2222 and 3333 have earned commissions for customer 123456's purchase of the radio. The checkout application 112 may make this determination based at least in part on the data in table 201, which reflects that sales associate 3333 provided a medium quality interaction that lasted nearly the entire duration of the customer's interaction with the radio, while sales associate 222 provided a high quality interaction for half of the customer's interaction with the radio. In such a case, the checkout application 112 may reference one or more business rules in the rules 114 specifying how to partition the commission, whether the associates are eligible for the commission, and the like. In some aspects, the checkout application 112 may only award a commission to one sales associate to the exclusion of other assisting sales associate. As shown, for example, the checkout application 112 has determined that sales associate 2020 has earned a commission for customer 654321's purchase of a computer. The checkout application 112 may make this determination based at least in part on the data in table 201, which reflects that sales associate 1520 provided a low quality interaction with the customer, which only lasted two minutes, while sales associate 2020 provided a high quality interaction with the customer that lasted five minutes (and also began when sales associate 1520 stopped interacting with the customer).

In some aspects, a sales associate may earn a commission for sales that are not completed in-store, and that may occur hours after the sales associate interacted with the customer. For example, as shown in table 202, customer 123456 purchased the radio online nearly 9 hours after being in the store. However, due to the assistance provided by the sales associates, the checkout application 112 computed commissions for sales associates 2222 and 3333. As shown in table 202, however, not all sales may result in commissions. For example, customer 123456's purchase of the laptop did not result in a commission, because as reflected in the table 201, the checkout application 112 did not detect any sales associate interacting with the customer while the customer interacted with the laptop.

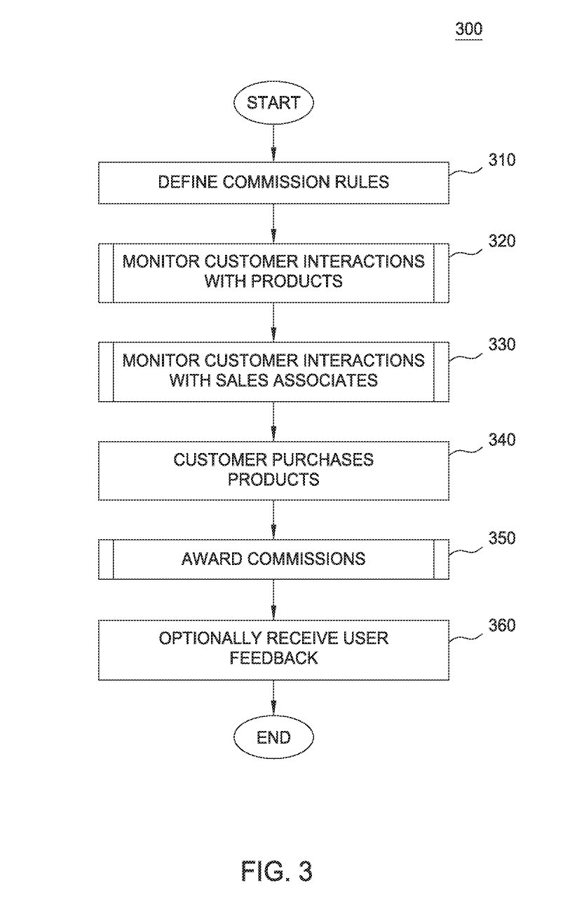

FIG. 3 illustrates a method 300 to compute sales associate commissions, according to one aspect. In at least one aspect, the checkout application 112 performs the steps of the method 300. Generally, the checkout application 112 may perform the steps of the method 300 to compute commissions for sales associates when customers purchase products from a retailer. The method 300 begins at step 310, where a user, such as a manager of a retail store, defines rules for computing and awarding commissions in the rules 114. Examples of rules for computing and awarding commissions include, without limitation, a maximum value of a given commission, a formula to compute commissions, a number of sales associates entitled to share a commission, job roles (or positions) entitled to earn a commission, and the like. In at least one aspect, the rules 114 may also include predefined rules.

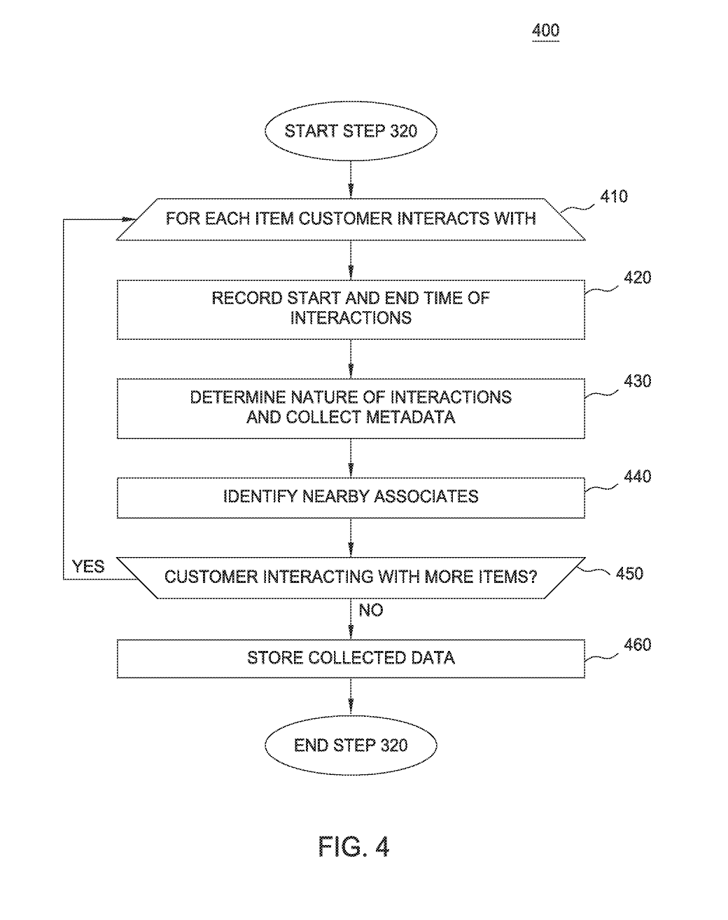

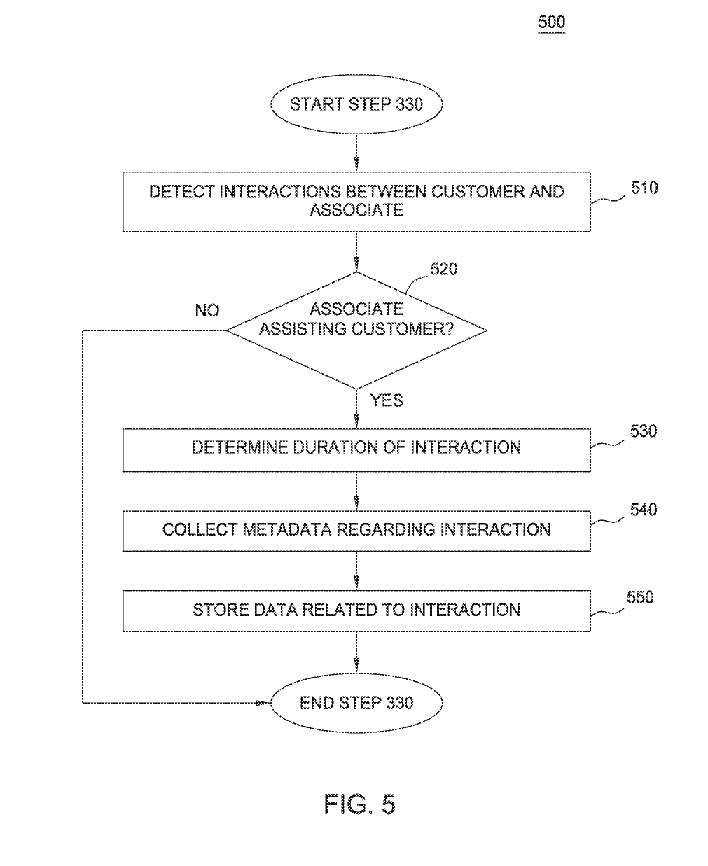

At step 320, described in greater detail with reference to FIG. 4, the checkout application 112 may monitor interactions between customers and products. The interactions may be real-world interactions, such as picking up a product in a retail store, placing the product in a physical shopping cart. The interactions may also be technology based interactions, such as browsing a product page on a retailer's website, or adding a product (in a retail store) to a virtual shopping cart using a mobile device 150 executing an instance of the checkout application 112 (as part of a self-checkout process). Generally, whenever a customer interacts with a product, the checkout application 112 may create an association between the customer and the product in the interaction data 115. The checkout application 112 may use any type of sensor to detect interactions between the customer and a product, such as cameras, Bluetooth®, iBeacons®, NFC, GPS, Wi-Fi, software modules in a virtual shopping environment, and the like. At block 330, described in greater detail with reference to FIG. 5, the checkout application 112 may monitor customer interactions with sales associates. Doing so may allow the checkout application 112 to determine which, if any, sales associates have earned a commission by assisting the customers in deciding to purchase a given product. Whenever a customer interacts with a sales associate, the checkout application 112 generally creates an association between the customer and the sales associate in the interaction data 115, allowing the checkout application 112 to further associate sales associates with products that the customers may purchase.

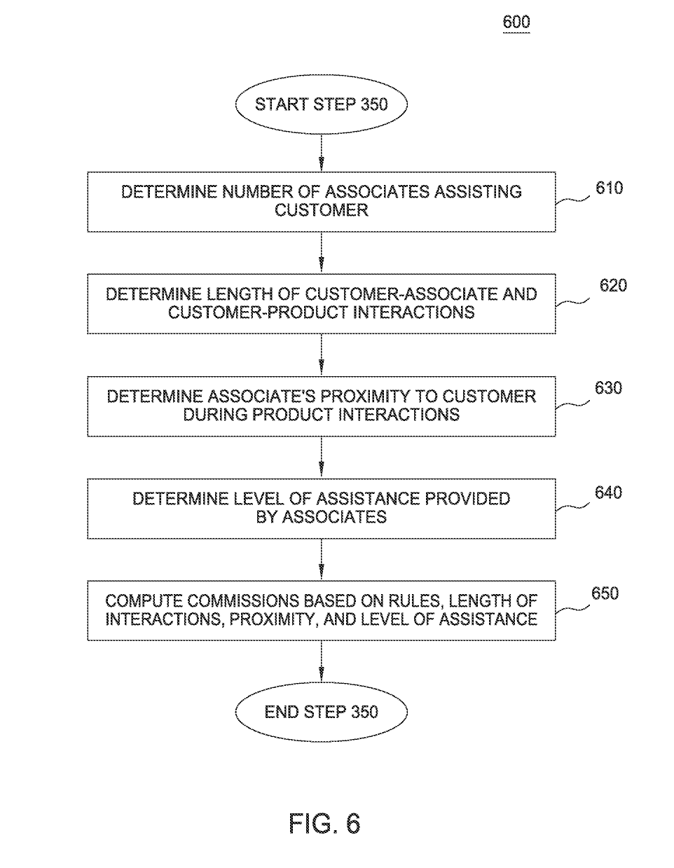

At step 340, the checkout application 112 may determine that a customer has purchased a product. The customer may purchase a product in the retail store, or on an online interface (or application) provided by the retailer. At block 350, described in greater detail with reference to FIG. 6, the checkout application 112 may compute commissions for sales associates. Generally, the checkout application 112 computes commissions based on the interactions monitored at steps 320 and 330 and the rules for commissions in the rules 114. At step 360, the checkout application 112 may optionally receive user feedback related to the purchase. When receiving feedback, the checkout application 112 may know which associates may be the subject of the feedback, namely the sales associates the checkout application 112 detected interacting with the customer at step 330.

FIG. 4 illustrates a method 400 to monitor customer interactions with products, according to one aspect. Generally, the checkout application 112 may perform the steps of the method 400 to detect interactions between customers and products, as well as capture metadata or other attributes of the interactions. The method begins at step 410, where the checkout application 112 performs a loop including steps 420-450 for each product the checkout application 112 determines that the customer interacts with. As previously indicated, the checkout application 112 may determine that customers are interacting with products using any number of different technologies, such as cameras, proximity sensors, Bluetooth®, Wi-Fi, NFC, GPS, iBeacons®, and the like. At step 420, the checkout application 112 may create an association between the customer and the product. In at least one aspect, the checkout application 112 stores an indication of the association in the interaction data 115. At step 430, the checkout application 112 may determine the type of the interaction between the customer and the product, as well as collect metadata describing the interaction. For example, the checkout application 112 may determine, by analyzing video data from a security camera, that a customer has picked up a portable media player. The checkout application 112 may then collect different attributes related to the customer's interaction with the media player, which may include, without limitation, when the customer picked up the media player, when the customer stopped holding the media player, how long the customer interacted with the media player, whether the customer opened the package, and the like. At block 440, the checkout application 112 may identify any nearby sales associates while the customer is interacting with the product. The checkout application 112 may use any suitable technology to identify any nearby sales associates, such as microphones to pick up conversations, proximity sensors, GPS, and the like. At block 450, the checkout application 112 determines whether the customer interacts with more items. If the customer interacts with more items, the checkout application 112 may return to step 410. If the customer does not interact with more items, the checkout application 112 may proceed to step 460, where the checkout application 112 stores the data collected while monitoring the customer's interactions at steps 420-440.

FIG. 5 illustrates a method 500 to monitor customer interactions with sales associates, according to one aspect. Generally, the checkout application 112 may perform the steps of the method 500 to monitor sales associate/customer interactions and collect data attributes describing the interactions. At step 510, the checkout application 112 may detect interactions between customers and sales associates. As previously indicated, the checkout application 112 may leverage any type of technology to detect interactions between sales associates and customers, such as analyzing data from microphones, cameras, mobile device technology, NFC, Bluetooth®, GPS, and the like.

At step 520, the checkout application 112 may determine whether the associate is assisting the customer. For example, the checkout application 112 may analyze a text transcription of a conversation recorded by a microphone on the sales associate's mobile device to determine what the parties were discussing. If the checkout application 112 determines they are talking about a recent sporting event, the checkout application 112 may determine that the sales associate is not assisting the customer. If, however, the checkout application 112 determines that the sales associate is answering the customer's questions about a product, the checkout application 112 may determine that the sales associate is assisting the customer. Similarly, if video data indicates that the parties are talking while gesturing to a specific product, the checkout application 112 may determine that the sales associate is assisting the customer. If, however, the checkout application 112 determines that the sales associate is merely greeting the customer while walking by the customer, the checkout application 112 may determine that the sales associate is not assisting the customer.

If, at step 520, the checkout application 112 determines that the associate is not assisting a customer, the method 500 ends. If the checkout application 112 determines that the sales associate is assisting the customer, the checkout application 112 proceeds to step 530, where the checkout application 112 may collect metadata or attributes of the interaction. For example, the checkout application 112 may determine a location in the store where the interaction occurred, a length of the interaction, a time of the interaction, and the like. At step 540, the checkout application 112 may determine any products that are associated with the interaction. In one embodiment, the checkout application 112 may reference the interaction data 115 to determine if an interaction with the same customer and a product exists. The checkout application 112 may limit the customer/product interactions to those interactions occurring within a threshold time of the customer/sales associate interactions. In another aspect, the checkout application 112 may determine whether any products are associated with the discussion by extracting this information from the interaction. For example, the checkout application 112 may analyze a recording of the conversation to determine that the parties discussed specific products. As another example, the checkout application 112 may analyze video data which shows the customer and sales associate interacting while holding specific products. At block 550, the checkout application 112 may store the data related to the interaction in the interaction data 115.

FIG. 6 illustrates a method 600 to compute commissions, according to one aspect. Generally, the checkout application 112 may perform the steps of the method 600 to determine whether to award a commission for a sale, and if so, which sales associates have earned the commission. At step 610, the checkout application 112 may determine a number of associates assisting a customer who has made a purchase. The checkout application 112 may determine which, if any, associates assisted a customer by referencing the data in the interaction data 115. For example, the checkout application 112 may determine that the user, who purchased a radio, interacted with a radio at 4:09 PM, while a first sales associate interacted with the customer from 4:07-4:10 PM, and a second sales associate processed the customer's transaction at 4:25 PM. In such a case, the checkout application 112 may likely associate the first sales associate with the sale of the radio, but not the second sales associate (as the second sales associate likely did not play a role in leading to the purchase).

At step 620, the checkout application 112 may determine the length and time of any customer/associate and customer/product interactions. The checkout application 112 may retrieve this data from the interaction data 115. As previously indicated, the checkout application 112 may only award commissions to sales associates whose assistance led to the customer's decision to purchase a product. Therefore, the checkout application 112 may leverage the timing and duration of each interaction to determine some temporal connection between the customer/product interaction and the customer/sales associate interaction.

At step 630, the checkout application 112 may determine the sales associate's proximity to the customer during customer/product interactions. Again, the proximity data may be stored in the interaction data. If, for example, the checkout application 112 determines that the sales associate was 5 meters away from the customer while the customer interacted with a product, the checkout application 112 may determine that this is not within a threshold distance (such as 2 meters) to qualify as actual assistance. In such a case, the checkout application 112 may subsequently determine that the sales associate is not entitled to a commission (absent other factors). If, however, the checkout application 112 determines that the sales associate was one meter away from the customer during the interactions, the checkout application 112 may determine that the distance was within the threshold, and therefore likely assisting the customer as they shopped.

At step 640, the checkout application 112 may determine a level of assistance provided by the sales associates. Generally, at step 640, the checkout application 112 determines whether the associate's level of assistance rose to a threshold level, possibly entitling the sales associate to a commission. For example, the checkout application 112 may analyze the interaction data 115 to determine a content of the interaction, the number of products they discussed, whether the customer appeared to be satisfied with their interaction, and the like. In at least one aspect, the checkout application 112 may compute a score for the associate/customer interaction based on the data stored in the interaction data 115, and store the score in the interaction data 115. The checkout application 112 may compute the score based on any number of attributes, such as length of the interaction, proximity between the parties, topics discussed, number of products discussed, the tone of the interaction, and the like. At step 650, the checkout application 112 may compute a commission (if any) based on at least one of the rules in the rules 114, the length and/or time of the interactions, the proximity of the parties during the interactions, and the level of assistance provided by the associate (which may be reflected by the score computed at step 640). Generally, the checkout application 112 may leverage any number of factors in determining whether to award a commission. In at least one aspect, the checkout application 112 may apply the data in the interaction data 115 to the rules in the rules 114 may determine whether a sales associate is entitled to a commission. When the checkout application 112 determines one or more sales associates are entitled to a commission, the checkout application 112 may store this information in the transaction data 116.

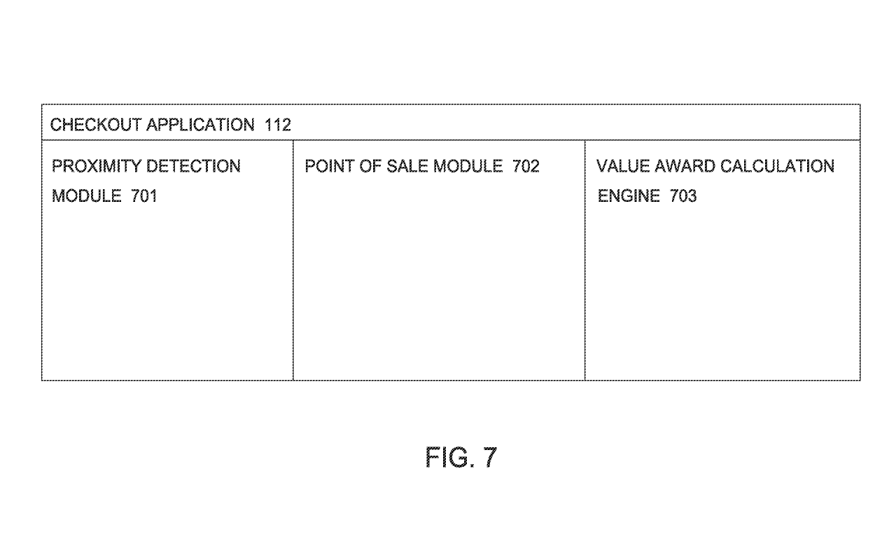

FIG. 7 illustrates components of the checkout application 112, according to one aspect. As shown, the checkout application 112 includes a proximity detection module 701, a point of sale module 702, and a value award calculation (VAC) engine 703. The proximity detection module 701 is configured to detect the proximity of customers and products as well as customers and sales associates in a retail store, as described in greater detail above. The proximity detection module 701 may leverage data received from one or more proximity modules 119 to determine that the customer is in proximity with a product or another person. Furthermore, the proximity detection module 701 may analyze video or image data from the cameras 125 to detect a customer's proximity to a product and/or sales associate. The point of sale module 702 is generally configured to process customer transactions, including sales, refunds, exchanges, and the like. The VAC engine 703 is configured to apply the rules 114 to collected interaction data 115 in order to compute commissions (also referred to as value awards), as described in greater detail above.

Advantageously, aspects disclosed herein award commissions to sales associates based on interactions between customers and products, as well as customers and sales associates. By collecting attributes of the interactions, aspects disclosed herein may award commissions that more accurately reflect which, if any, sales associates are entitled to a commission.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made herein to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the aspects of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the aspects of the present invention, a user may access applications or related data available in the cloud. For example, the checkout application 112 could execute on a computing system in the cloud and compute commissions for sales associates. In such a case, the checkout application 112 could compute commissions for sales associates and store the computed commissions at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A system, comprising:
a computer processor; and
a memory containing a program, which when executed by the processor, performs an operation comprising:
calculating a first duration of time of a first interaction between a first person and an object;
detecting a second interaction between the first person and a second person based on at least one of:
a proximity between the first person and the second person, the proximity being detected by a proximity detection module; and
a second duration of time during which the first person and the second person remain in the proximity; and
upon determining that the first person has purchased the object:
computing, by the processor, an award to apply to the second person;
wherein the processor computes the award on the basis of one or more rules that take as inputs the first interaction and the second interaction.

2. The system of claim 1, wherein the first interaction is detected by at least one of: (i) a camera in a retail store, (ii) determining that a mobile device of the first person is within a predefined distance of the product, (iii) determining that the first person has scanned the product, (iv) determining that the first person has placed the product in a shopping cart, and (v) determining that the first person has visited a web page for the product.

3. The system of claim 1, wherein the second interaction is detected by at least one of: (i) a camera in a retail store, (ii) determining that a mobile device of the first person is within a predefined distance of a mobile device of the second person, and (iii) capturing, by a microphone, a conversation between the second person and the first person.

4. The system of claim 1, wherein the first and second interactions occur in a retail store, and wherein the first person purchases the product via an online interface.

5. The system of claim 1, wherein the processor computes the award upon determining that the second duration of time exceeds a predefined assistance threshold.

6. The system of claim 1, wherein the one or more rules specify: (i) a maximum amount of time between the first and second interactions, (ii) a threshold amount of time for the second duration of time, (iii) a maximum number of persons eligible to receive at least a portion of the award, and (iv) a set of roles eligible to receive awards.

7. A computer-implemented method, comprising:
calculating a first duration of time of a first interaction between a first person and an object;
detecting a second interaction between the first person and a second person based on at least one of:
a proximity between the first person and the second person, the proximity being detected by a proximity detection module; and
a second duration of time during which the first person and the second person remain in the proximity; and
upon determining that the first person has purchased the object:
computing, by operation of one or more processors, an award to apply to the second person; wherein the processors compute the award on the basis of one or more rules that take as inputs the first interaction and the second interaction.

8. The method of claim 7, wherein the first interaction is detected by at least one of: (i) a camera in a retail store, (ii) determining that a mobile device of the first person is within a predefined distance of the product, (iii) determining that the first person has scanned the product, (iv) determining that the first person has placed the product in a shopping cart, and (v) determining that the first person has visited a web page for the product.

9. The method of claim 7, wherein the second interaction is detected by at least one of:
(i) a camera in a retail store, (ii) determining that a mobile device of the first person is within a predefined distance of a mobile device of the second person, and (iii) capturing, by a microphone, a conversation between the second person and the first person.

10. The method of claim 7, wherein the first and second interactions occur in a retail store, and wherein the first person purchases the product via an online interface.

11. The method of claim 7, wherein the processor computes the award upon determining that the second duration of time exceeds a predefined assistance threshold.

12. The method of claim 7, wherein the processor computes the award upon determining that the first and second interactions occur within a threshold amount of time.

13. The method of claim 7, wherein the one or more rules specify: (i) a maximum amount of time between the first and second interactions, (ii) a threshold amount of time for the second duration of time, (iii) a maximum number of persons eligible to receive at least a portion of the award, and (iv) a set of roles eligible to receive awards.

14. A computer program product, comprising:
computer-readable code, which when executed by a processor, performs an operation comprising:
calculating a first duration of time of a first interaction between a first person and an object;
detecting a second interaction between the first person and a second person based on at least one of:
a proximity between the first person and the second person, the proximity being detected by a proximity detection module; and
a second duration of time during which the first person and the second person remain in the proximity; and
upon determining that the first person has purchased the object:
computing, by the processor, an award to apply to the second person;
wherein the processor computes the award on the basis of one or more rules that take as inputs the first interaction and the second interaction.

15. The computer program product of claim 14, wherein the first interaction is detected by at least one of: (i) a camera in a retail store, (ii) determining that a mobile device of the first person is within a predefined distance of the product, (iii) determining that the first person has scanned the product, (iv) determining that the first person has placed the product in a shopping cart, and (v) determining that the first person has visited a web page for the product.

16. The computer program product of claim 14, wherein the second interaction is detected by at least one of: (i) a camera in a retail store, (ii) determining that a mobile device of the first person is within a predefined distance of a mobile device of the second person, and (iii) capturing, by a microphone, a conversation between the second person and the first person.

17. The computer program product of claim 14, wherein the first and second interactions occur in a retail store, and wherein the first person purchases the product via an online interface.

18. The computer program product of claim 14, wherein the processor computes the award upon determining that the second duration of time exceeds a predefined assistance threshold.

19. The computer program product of claim 14, wherein the processor computes the award upon determining that the first and second interactions occur within a threshold amount of time.

20. The computer program product of claim 14, wherein the one or more rules specify: (i) a maximum amount of time between the first and second interactions, (ii) a threshold amount of time for the second duration of time, (iii) a maximum number of persons eligible to receive at least a portion of the award, and (iv) a set of roles eligible to receive awards.
